(19) United States
(12) Patent Application Publication
(10) Pub. No.: US 2002/0113378 A1
(43) Pub. Date: Aug. 22, 2002

(54) Packing

(75) Inventors: Takao Murakami, Shizuoka-ken (JP); Makoto Yamanashi, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/073,939

(22) Filed: Feb. 14, 2002

(30) Foreign Application Priority Data
Feb. 22, 2001 (JP) P2001-046844

(51) Int. Cl. F16J 15/46

(52) U.S. Cl. 277/645

(57) ABSTRACT

In a packing (20) interposed between inner and outer peripheries of two members fitted to each other and in a state of being attached to one of two members, pressure contacting a lip portion (21) with another, thereby sealing a gap between both of the members, wherein a hollow portion (22) is provided at least in an inner side of the lip portion (21). The hollow portion (22) is formed according to a gas assist molding.

### BACKGROUND OF THE INVENTION

The present invention relates to packing mainly provided in a fitting portion of a waterproof connector.

The packing provided in the fitting portion of the waterproof connector is generally molded by a rubber material having an even elastic property. FIG. 1 shows an example of use thereof. In FIG. 1, reference numeral 1 denotes a female connector, and reference numeral 2 denotes a male connector. A male terminal 3 is attached to a synthetic resin housing 1A of the female connector 1, and a female terminal 4 fitted to the male terminal 3 is attached to a synthetic resin housing 2A of the male connector 2. The female terminal 4 is received in a terminal receiving chamber 5 of the housing 2A, and a gap between an electric wire 6 extending rearward from the female terminal 4 and an inner peripheral wall of the terminal receiving chamber 5 is sealed by a rubber plug 7 fitted to an outer periphery of the electric wire 6.

The housing 2A of the male connector 2 has a main body portion 8 fitted to an inner periphery of the female connector 1, and a hood portion 9 provided in an outer peripheral side of the main body portion 8 and laying over the outer periphery of the female connector 1. A rubber packing 10 is attached to the outer periphery of the main body portion 8. When fitting the male connector 1 and the female connector 2 to each other, a lip portion 11 of the packing 10 is in pressure contact with the inner periphery of the housing 1A of the female connector 1, whereby the gap between the housings 1A and 2A in the male and female connectors 1 and 2 is sealed. Reference numeral 15 denotes a holder for preventing the packing 10 from coming off after attaching the packing 10 to the main body portion 8.

A seal performance applied by the packing 10 can be secured by a margin of collapse of the packing 10 at a time of fitting the male and female connectors 1 and 2 to each other. Accordingly, the margin of collapse of the packing 10 is secured by making a size B of the lip 11 of the packing 10 larger than a size A of the female connector housing 1A.

### SUMMARY OF THE INVENTION

However, in the case of this kind of packing 10, the seal performance is increased according to an increase of the margin of collapse of the packing 10 at a time of fitting the male and female connectors 1 and 2 to each other, however, when increasing the margin of collapse, there is a problem that a fitting load of the connector is increased.

Then, in order to increase the seal performance and reduce the connector-fitting load, it is considered to reduce a hardness of the rubber in the packing 10. However, in the case of reducing the hardness of the rubber, it is possible to solve the problem mentioned above, however, it is hard to define a shape of the packing due to softness, and there is a problem that an assembling property of the packing 10 in the housing is deteriorated.

The present invention is made by taking the matters mentioned above into consideration, and an object of the present invention is to provide a packing which can intend to reduce a connector fitting load and improve an assembling property in a connector housing.

According to a first aspect of the present invention, there is provided a packing interposed between inner and outer peripheries of two members fitted to each other and in a state of being attached to one of two members, pressure contacting a lip portion with another, thereby sealing a gap between both of the members, wherein a hollow portion is provided at least in an inner side of the lip portion.

Since the packing is structured such that the hollow portion exists in the inner side of the lip portion even in the case of being molded by a hard rubber, the lip portion is kept in a state being easily collapsed (easily deformed in an elastic manner). Accordingly, since the lip portion is kept in the state being easily collapsed even when the margin of collapse of the lip portion is set to be large for the purpose of increasing a sealing performance, a resistance of the packing at a time of fitting two members to each other becomes small. As a result, it is possible to reduce a fitting load of two members. Further, since it is possible to mold the whole by the hard rubber while restricting the fitting load of two members small, it is possible to make an outer shape of the packing be easily defined, so that it is possible to intend to improve an assembling property in the member.

Further, according to a second aspect of the present invention, there is provided packing as recited in the first aspect mentioned above, wherein the hollow portion is formed according to a gas assist molding.

Since the packing is structured such that the hollow portion is formed according to the gas assist molding, it is possible to form the hollow portion having an optional size in the inner portion of the packing only by leaving a small injection port for charging the gas on a front surface thereof.

According to a third aspect of the present invention, there is provided a packing as recited in the aspects mentioned above, wherein a low hardness member which is softer than a main body portion of the packing is charged in the hollow portion.

Since the packing is structured such that the low hardness member is charged in the hollow portion, it is possible to apply elasticity corresponding to a softness of the low hardness member to the lip portion.

According to a fourth aspect of the present invention, there is provided a packing interposed between inner and outer peripheries of two members fitted to each other and in a state of being attached to one of two members, pressure contacting a lip portion with another, thereby sealing a gap between both of the members, wherein only a front layer portion is made hard and an inner layer portion is kept in a state of being softer than the front layer portion.

Since the packing is structured such that the front layer portion is hard and the inner layer portion is soft, it is possible to easily define an outer shape of the packing and it is possible to intend to improve an assembling property in the member. Further, since the inner layer portion is soft, the lip portion is kept in a state being easily collapsed (easily elastically deformed). Accordingly, since the lip portion is kept in the state being easily collapsed even when the margin of collapse of the lip portion is set to be large for the purpose of increasing a sealing performance, a resistance of the packing at a time of fitting two members to each other becomes small. As a result, it is possible to reduce a fitting load of two members. In this case, in order to make only the front layer portion hard, it is possible to employ a method of vulcanizing the front layer portion in a limited manner.

### BRIEF DESCRIPTION OF THE DRAWINGS

FIG. 1 is a cross sectional view of a waterproof connector in which packing is used;

FIG. 2 is a cross sectional view of packing according to a first embodiment of the present invention;

FIG. 3 is a cross sectional view of a packing according to a second embodiment of the present invention; and

FIG. 4 is a cross sectional view of packing according to a third embodiment of the present invention.

### DESCRIPTION OF THE PREFERRED EMBODIMENT

A description will be given below of embodiments according to the present invention with reference to the accompanying drawings.

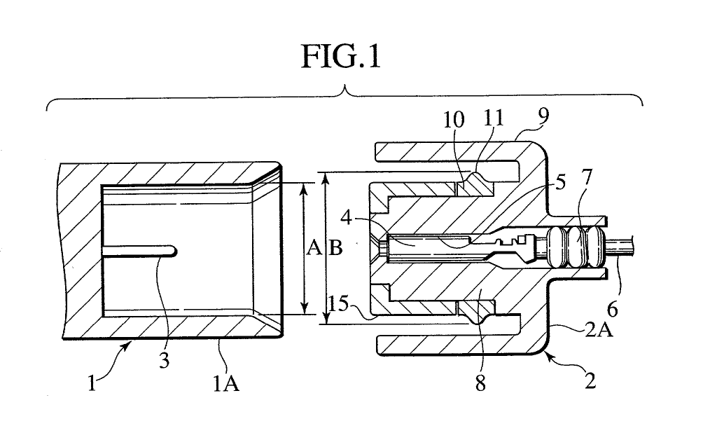

A packing exemplified below is used in place of the packing 10 in the waterproof connector in FIG. 1, and is structured such as to seal a gap between housings 1A and 2A in both of connectors 1 and 2 by pressure contacting a lip portion with an inner periphery of the female connector housing 1A at a time of fitting the connector in a state of being attached to an outer periphery of a main body portion 8 of the male connector housing 2A. In this case, structures corresponding to two members stated in claims are the housings 1A and 2A of the male and female connectors 1 and 2.

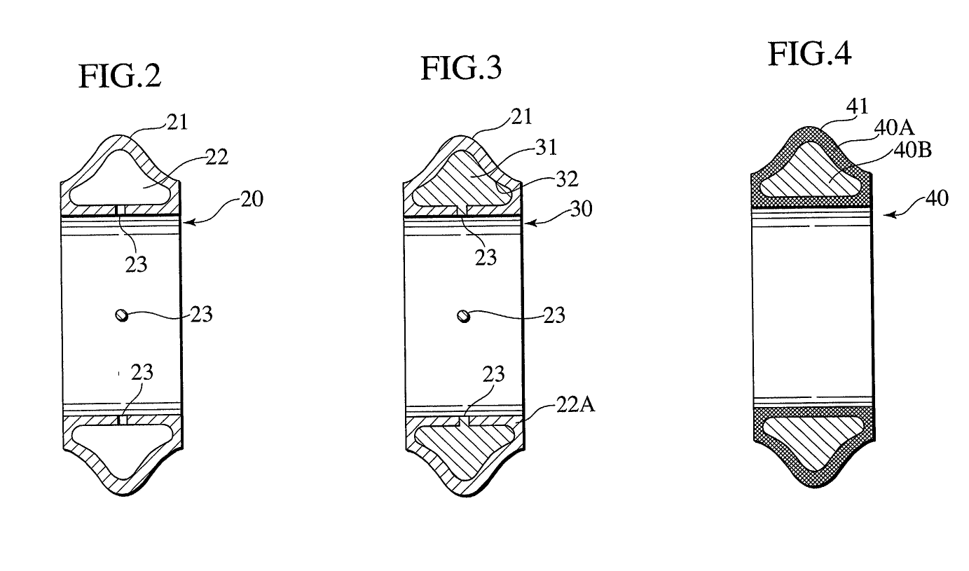

FIG. 2 shows a cross section of packing 20 according to a first embodiment of the present invention.

The packing 20 is integrally molded by a hard rubber as a whole, and has a hollow portion 22 formed according to a gas assist molding in an inner side of the lip 21.

Reference numeral 23 denotes a gas injection port. The gas injection ports 23 are provided in suitable portions on an inner peripheral surface of the packing 20. In the case of this packing 20, since the hollow portion 22 is formed according to the gas assist molding, it is possible to form the hollow portion 22 having an optional size in the inner portion of the packing 20 only by leaving the small injection port 23 for charging the gas on an inner peripheral surface (a portion hidden away at a time of being attached to the connector housing).

Further, since the packing 20 is wholly molded by the hard rubber and the hollow portion 22 is provided in the inner side of the lip portion 21, the lip portion 21 is kept in a state being easily collapsed (easily elastically deformed). Accordingly, even when a margin of collapse of the lip portion 21 is set to be large for the purpose of increasing a seal performance, the lip portion 21 is kept in a state of being easily collapsed, so that it is possible to reduce a fitting load of the connector. Further, since the whole is molded by the hard rubber, the outer shape of the packing 20 is easily defined, so that there is an advantage that an assembly in the connector housing can be easily executed.

In this case, the gas assist molding corresponds to a method of molding while charging the gas from the injection port 23, that is, a known molding method capable of forming a hollow portion at a desired position, and is also called as a hollow injection molding method.

FIG. 3 shows a cross section of packing 30 according to a second embodiment of the present invention.

The packing 30 is structured such that a low hardness member 31 which is softer than the main body portion 20A of the packing is charged in a hollow portion 22 of the packing 20 according to the first embodiment mentioned above. As the low hardness member 31, a butyl rubber, a gel or the like can be employed.

In the case of charging the low hardness member 31 into the hollow portion 22 as this packing 30, it is possible to apply an elastic force corresponding to a softness of the low hardness member 31 to the lip portion 21. Further, it is possible to freely adjust a collapse easiness of the packing.

FIG. 4 shows a cross section of packing 40 according to a third embodiment.

This packing 40 is structured such that only a front layer portion 40A is made hard according to a vulcanization and an inner layer portion 40B is kept in a state of being softer than the front layer portion 40A.

Since the front layer portion 40A is made hard, an outer shape of the packing 40 is easily defined, and an assembling property in the connector housing is kept well. Further, since the inner layer portion 40B is soft, a lip 41 is kept in a state of being easily collapsed (easily deformed in an elastic manner), so that even when a margin of collapse of the lip portion 41 is made large, it is possible to reduce a fitting load of the connector.

What is claimed is:

1. A packing interposed between inner and outer peripheries of two members fitted to each other and in a state of being attached to one of two members, pressure contacting a lip portion with another, thereby sealing a gap between both of the members comprising:
a hollow portion is provided at least in an inner side of the lip portion.

2. The packing according to claim 1, wherein
the hollow portion is formed according to a gas assist molding.

3. The packing according to claim 1, wherein
a low hardness member which is softer than a main body portion of the packing is charged in the hollow portion.

4. A packing interposed between inner and outer peripheries of two members fitted to each other and in a state of being attached to one of two members, pressure contacting a lip portion with another, thereby sealing a gap between both of the members, comprising:
a front layer portion; and
an inner layer portion, wherein
only the front layer portion is made hard and the inner layer portion is kept in a state of being softer than the front layer portion.
